(19) United States
(12) Patent Application Publication
(10) Pub. No.: US 2026/0316520 A1
(43) Pub. Date: Oct. 15, 2026

(54) SYSTEM OF AIR CONDITIONING DISTRIBUTION

(71) Applicant: Gun Smoke Customs, LLC, Montgomery, TX (US)

(72) Inventors: Derek Lynn Buster, Montgomery, TX (US); Melissa Ann Buster, Montgomery, TX (US); Avery Jonathan Buster, Montgomery, TX (US); Cassadi Annlynn Buster, Montgomery, TX (US); Preslee Ferriss Buster, Montgomery, TX (US)

(73) Assignee: Gun Smoke Customs, LLC, Montgomery, TX (US)

(21) Appl. No.: 19/258,587

(22) Filed: Jul. 2, 2025

Related U.S. Application Data
(60) Provisional application No. 63/667,059, filed on Jul. 2, 2024.

(51) Int. Cl. B60H 1/00

(52) U.S. Cl. CPC B60H 1/00564; B60H 1/00364

(57) ABSTRACT

A forced air splitter is configured for an air conditioning (AC) duct. The forced air splitter includes a stator with a stator opening. The stator opening includes a plurality of ribs. The stator extends from a wall of the AC duct into the AC duct and into a duct airflow. An actuator is arranged within the stator opening and between the plurality of ribs and the local AC register.

The actuator includes a guide vane having an inlet extending into the AC duct and into the duct airflow for splitting a local airflow from the duct airflow. The guide vane has an outlet communicating the inlet with the local AC register. The plurality of ribs are configured to permit the actuator to actuate. The inlet has an effective cross-sectional area in the longitudinal direction in the AC duct. Actuation of the actuator decreases the effective cross-sectional area of the inlet.

### BACKGROUND OF THE INVENTION

This invention relates generally to air conditioning (AC) systems for recreational vehicles that employ air-distribution and air return ducts extending along the interior ceiling. Recreational vehicles such as motor homes, travel trailers, fifth wheelers, recreational vans and the like, have air conditioning systems which contain air ducts to control the path of air within the interior attic of the vehicle. The air travels inside these ducts until reaching air registers dispersed throughout the cabin environment and discharge at various locations within the vehicle.

Decorative registers located in the interior environment may be selectively adjusted or closed so that a proportional volume of cool air can be delivered to a particular location than would otherwise be the case. Generally, however, equal volumes of conditioned air are not delivered throughout the interior of the vehicle at each register, thereby making the adjustments have little to no effect at the desired register.

### BRIEF SUMMARY OF THE INVENTION

The disclosure is directed to one or more AC registers with at least one forced air splitter or distributor to vary the proportion of the flow of air in directions other than the normal flow direction of air within the attic duct. Further, the at least one forced air splitter or distributor can be adjusted to control the volume of air flowing in two or more directions inside the attic duct prior to exiting any distribution register to the interior of the vehicle.

The disclosure further provides a forced air splitter for an air conditioning (AC) duct both extending in and configured for duct airflow in a longitudinal direction. The forced air splitter splits a local airflow from the duct airflow and communicates the local airflow to a local AC register. The forced air splitter comprises a stator with a stator opening. The stator opening includes a plurality of ribs. The stator extends from a wall of the AC duct into the AC duct and into the duct airflow. The forced air splitter comprises an actuator arranged within the stator opening and between the plurality of ribs and the local AC register. The actuator includes a guide vane having an inlet extending into the AC duct and into the duct airflow for splitting the local airflow from the duct airflow. The guide vane includes an outlet communicating the inlet with the local AC register for communicating the local airflow to the local AC register. The plurality of ribs are configured to permit the actuator to actuate. The inlet has an effective cross-sectional area in the longitudinal direction in the AC duct. Actuation of the actuator from a normal state toward an intermediate state decreases the effective cross-sectional area of the inlet in the longitudinal direction in the AC duct.

The disclosure also provides a system of AC management comprising an air-conditioner or forced air device, an AC duct, and a plurality of local AC registers. The AC duct is in communication with the air-conditioner for forced air device such that the air-conditioner or forced air device creates a duct airflow in a longitudinal direction of the AC duct. The plurality of local AC registers are in communication with the AC duct in sequence in the longitudinal direction of the AC duct. Each of the plurality of the local AC registers has a forced air splitter for splitting a local airflow from the duct airflow and communicating the local airflow to the local AC register. The local airflows among the plurality of local AC registers are balanced by actuation of the actuators without manipulating the local AC registers.

The disclosure additionally provides a recreational vehicle (RV) comprising an air-conditioner or forced air device, an AC duct, and a plurality of local AC registers. The AC duct is in communication with the air-conditioner for forced air device such that the air-conditioner or forced air device creates a duct airflow in a longitudinal direction of the AC duct. The plurality of local AC registers are in communication with the AC duct in sequence in the longitudinal direction of the AC duct. Each of the plurality of the local AC registers has a forced air splitter for splitting a local airflow from the duct airflow and communicating the local airflow to the local AC register.

In an aspect, the actuator further comprises an actuator wall. Actuation from the normal state toward the intermediate state causes the actuator wall to supplant the inlet in the longitudinal direction, decreasing the effective cross-sectional area of the inlet in the longitudinal direction in the AC duct.

In another aspect, the actuator comprises a plurality of fins arranged within the guide vane and extending in an actuator-normal direction. The plurality of fins are spaced apart from one another in an actuator-lateral direction. Actuation of the actuator causes the actuator-normal direction to actuate relative to the longitudinal direction and the plurality of fins to restrict the local airflow, decreasing the effective cross-sectional area of the inlet in the longitudinal direction in the AC duct.

In an additional aspect, the actuator is a rotor that is coaxial with the configuration of the ribs such that the actuation of the rotor comprises rotation within the ribs. The actuator-normal direction is parallel to the longitudinal direction in a normal state and actuates toward the lateral direction during rotation from the normal state toward an intermediate state.

In another aspect, the rotor further comprises a rotor wall. Rotation from the normal state toward the intermediate state causes the rotor wall to supplant the inlet in the longitudinal direction, decreasing the effective cross-sectional area of the inlet in the longitudinal direction in the AC duct.

In a further aspect, the ribs are configured to reciprocate a domed top surface of the rotor.

In yet another aspect, the local airflow comprises a portion of the duct airflow. The inlet comprises an upper lip within the AC duct. The upper lip intercepts the portion of the duct airflow comprising the local airflow and redirects it away from the longitudinal direction.

### BRIEF DESCRIPTION OF THE SEVERAL VIEWS OF THE DRAWING(S)

FIGS. 1A-1C are depictions of an RV AC system embodiment of the present disclosure.

FIGS. 2A-C represent an RV AC system embodiment of the present disclosure under varying conditions.

FIGS. 3-5 are perspective views of an embodiment of an AC system with a plurality of AC registers including a forced air splitter.

FIG. 6 illustrates an embodiment of a forced air splitter of the present disclosure in a normal state.

FIG. 7 are perspective views of an embodiment of a forced air splitter of the present disclosure in an exploded view.

FIG. 8 illustrates airflow interacting with an embodiment of the forced air splitter of the present disclosure in the normal state.

FIG. 9 illustrates an embodiment of the forced air splitter of the present disclosure in an intermediate state.

FIG. 10 illustrates airflow interacting with an embodiment of the forced air splitter of the present disclosure in the intermediate state.

FIGS. 11A-11E are perspective views of an embodiment of a forced air splitter of the present disclosure.

FIG. 12 illustrates an embodiment of the stator of the present disclosure with screw-in tabs.

### DETAILED DESCRIPTION OF THE INVENTION

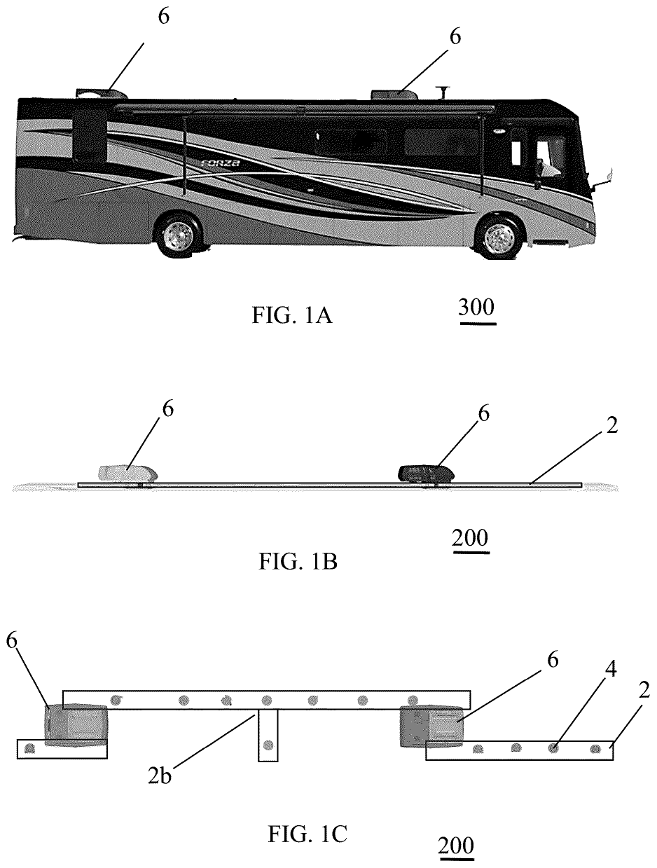

FIG. 1A is a view of a recreational vehicle (RV) 300 including an air-conditioner 6, or multiple. This air-conditioner 6 forces cool airflow to an interior environment of the RV, lowering the temperature of the interior environment.

FIG. 1B is a side view of part of the RV 300 of FIG. 1A, showing an AC system 200 for the RV 300 including an AC duct 2 associated with the air-conditioner 6 (or multiple). The AC duct 2 enables airflow from the air-conditioner 6 to flow along the AC duct 2 in a longitudinal direction to differing local areas of the internal environment.

FIG. 1C is a top view of part of the RV 300 of FIG. 1A, showing an AC system 200 for the RV 300 including an AC duct 2 associated with the air-conditioner 6 (or multiple). The AC duct 2 includes a plurality of AC registers 4 arranged within the AC duct 2 in the longitudinal direction at local areas within the interior environment. The AC registers 4 at the local areas enable airflow from the air-conditioner 6 within the AC duct 2 to the different local areas of the internal environment associated with the plurality of AC registers 4. In an embodiment such as FIG. 1C, the longitudinal direction follows the changing shape and direction of the elongation of the AC duct 2. In some examples, the air-conditioner 6 drives duct airflow 8 in two distinct longitudinal directions, or in a longitudinal direction that branches in more than one spatial direction based on the AC duct 2 having a wye or tee junction 2b, where duct airflow 8 is split into two directions. The present disclosure is applicable in any AC system 200 for an interior environment.

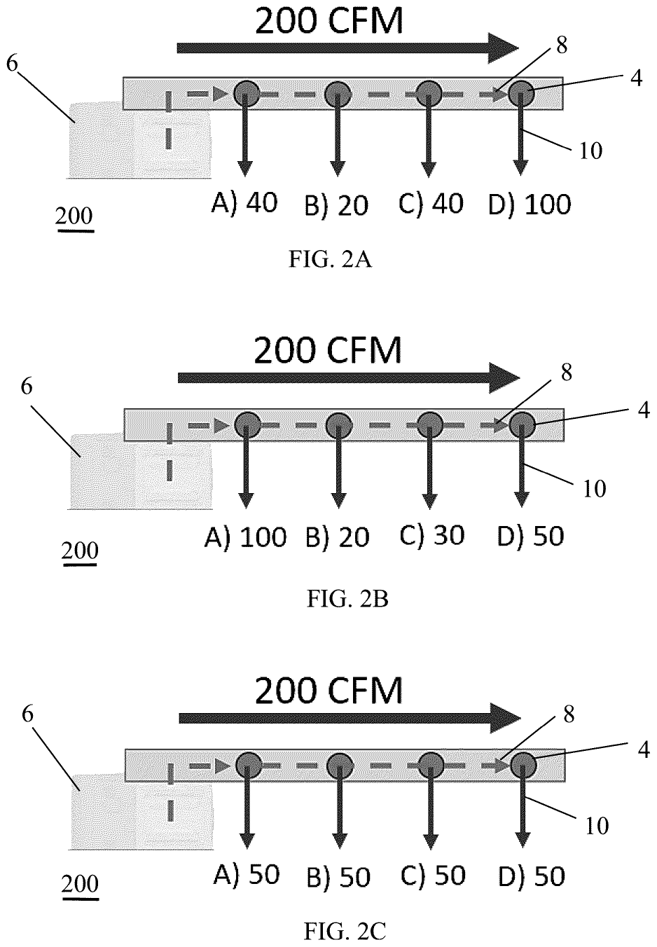

FIG. 2A illustrates such an AC system 200 in an RV 300, having an air conditioner 6 that supplies 200 cubic feet per minute (CFM) in airflow to the AC duct 2 in the longitudinal direction. This duct airflow 8 crosses four local AC registers 4 in sequence, with a variable duct airflow 8 at each local AC register 4 created by the loss of the local airflow 10 at the preceding AC register 4.

The AC system 200 of FIG. 2A operates without the aforementioned forced airflow splitter 100 in each of the four AC registers 4, with the result creating 100 CFM at the final AC register 4, with local airflow 10 decreased substantially at the other AC registers 4 relative to the last one. In this system configuration, even leveraging the local AC register 4 to manage airflow, a disproportionate amount of the duct airflow 8 bypasses the AC registers 4 until they experience a physical, in-line deadhead by the termination of the AC duct 2. This physical barrier and the resulting deadhead creates backpressure that escapes at the last AC register 4, creating a problematic cooling system in the RV. The passive local airflow path, or path of least resistance, offered by the AC registers 4 alone are insufficient to pull proportional CFM in the local airflows 10 until the AC duct 2 terminates.

FIG. 2B depicts the same AC system 200 with an unactuated forced air splitter 100 in the first AC register 4. In this configuration, the forced air splitter 100 resolves the problem of insufficient airflow at the first AC register 4, but creates a new imbalance of 100 CFM at the first AC register 4, rather than the last AC register 4.

FIG. 2C depicts the same AC system 200 with all four AC registers 4 utilizing the forced air splitter 100, wherein the splitter 100 is actuated to counterbalance the airflow profile of the first configuration of FIG. 2A, creating even airflow distribution across the system's four AC registers 4.

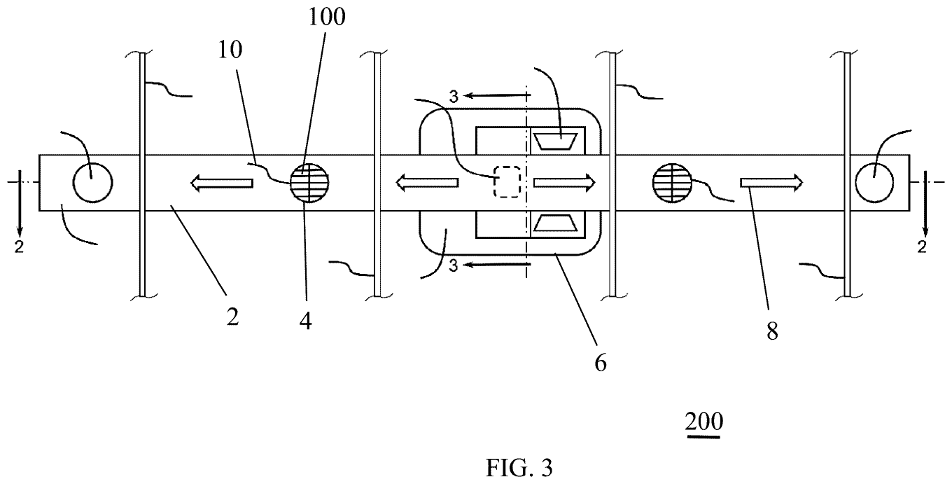

FIG. 3 illustrates an example of an AC system 200 from a bottom view. The AC system 200 includes an AC duct 2 associated with an air-conditioner 6. The air-conditioner 6 drives airflow along the AC duct 2, or duct airflow 8, in a longitudinal direction to differing local areas of the internal environment. The AC duct 2 includes a plurality of AC registers 4 arranged within the AC duct 2 in the longitudinal direction at local areas within the interior environment. The AC registers 4 are at different local areas of the internal environment. These AC registers 4 enable duct airflow 8 to reach the different local areas of the internal environment as local airflows 10 exiting the AC registers 4. Some AC registers 4 include a forced air splitter 100.

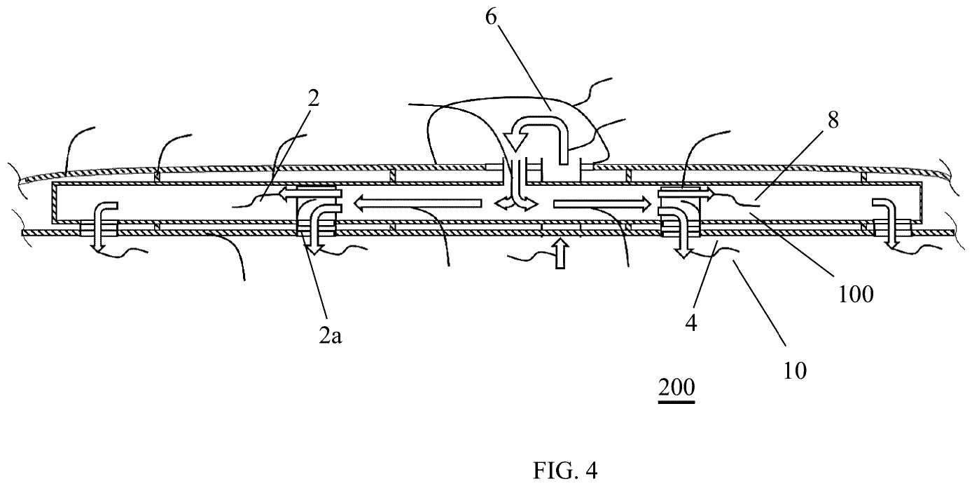

FIG. 4 illustrates an example of an AC system 200 from a lateral view. The AC system 200 includes an AC duct 2 extending in a longitudinal direction such that the air-conditioner 6 drives a duct airflow 8 along the AC duct 2 in the longitudinal direction. The AC duct 2 includes a plurality of AC registers 4 arranged in a wall 2a of the AC duct 2 such as a side on the bottom of the AC duct 2 (i.e., a bottom wall) or a wall disposed to a ceiling of the interior environment. An AC register 4 provides communication of the AC duct 2 to the interior environment. The AC register 4 provides communication of a local airflow 10, separating from the duct airflow 8, to a local zone in the interior environment. The plurality of AC registers 4 are distributed along a wall 2a of the AC duct 2 to distribute a plurality of local airflows 10 to a plurality of local zones to provide more even cooling of the interior environment. Some AC registers 4 include a forced air splitter 100. The air splitter 100 is connected to the AC duct 2 and/or the local AC register 4. The forced air splitter 100 extends into the AC duct 2 and into the duct airflow 8 for splitting the local airflow 10 from the duct airflow 8, and the forced air splitter 100 communicates the local airflow 10 with the local AC register 4.

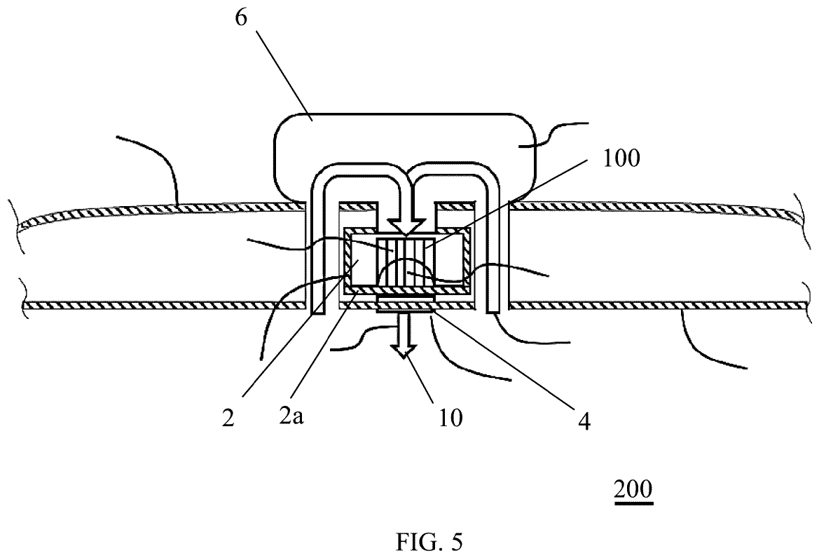

FIG. 5 illustrates an example of an AC system 200 from a longitudinal view. The AC duct 2 includes an AC register 4 arranged in a wall 2a of the AC duct 2 such as a side on the bottom of the AC duct 2 (i.e., a bottom wall) or a wall disposed to a ceiling of the interior environment.

FIG. 4 shows the forced air splitter 100 occupies most of the height of the AC duct 2. FIG. 5 shows the forced air splitter 100 only occupies about half of the width of the AC duct 2 in the longitudinal direction. In other embodiments, the forced air splitter 100 occupies the entirety of the AC duct such that both the duct airflow 8 and the local airflow 10 pass through the forced air splitter 100. Embodiments of the forced air splitter can occupy 75%, 50%, or 25%, or thereabouts.

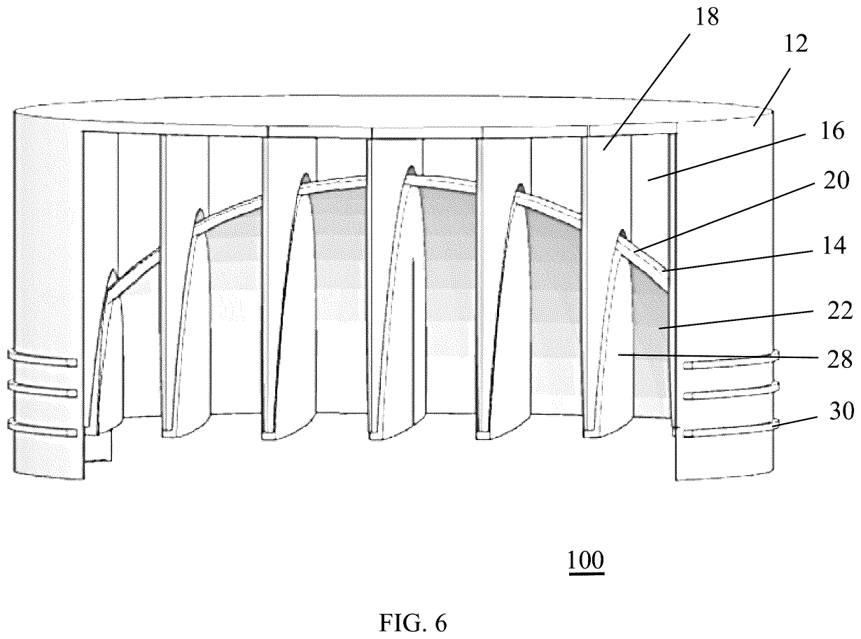

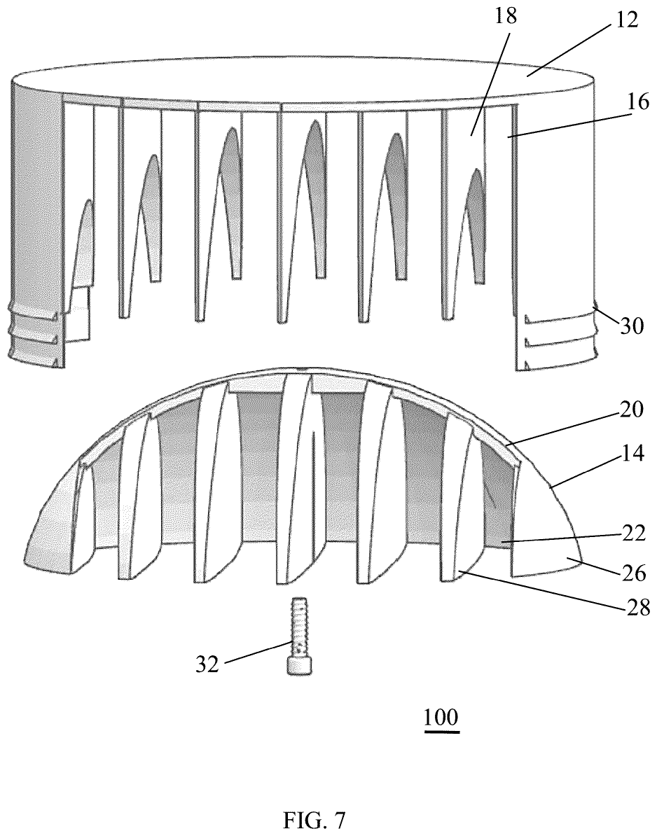

FIG. 6 illustrates an embodiment of a forced air splitter 100 of the present disclosure in a normal state. The forced air splitter 100 includes a stator 12 and an actuator such as a rotor 14. The actuator is positioned within the stator 12. The stator 12 includes a stator opening 16 with a plurality of ribs 18 located therein. Each rib 18 is connected to a ceiling of the stator 12 or otherwise fixed relative to the stator 12 such that they project downward toward the actuator. Each rib 18 further extends in the longitudinal direction, being configured to abut the actuator and/or abut the actuator's travel path. However, each rib 18 is slim in the lateral direction, creating a low profile in an longitudinal direction. The ribs 18 are so configured, in part, to permit airflow with minimal drag in the longitudinal direction. The ribs 18 are arranged with respect to one another in the lateral direction. The arrangement of the ribs 18 in the lateral direction can be configured to provide even support to the stator 12 and the actuator.

The actuator is arranged in the stator opening 16. The actuator includes a guide vane 20 having an inlet 22 for airflow. The rotor 14 includes a plurality of fins 28. In some embodiments, the stator 12 includes three rings 30, for mating with the AC system 200.

In an embodiment, an actuator such as rotor 14 faces the longitudinal direction in the normal state and has an actuator-normal direction that is coincident with the longitudinal direction in the normal state. The actuator further has an actuator-lateral direction that is coincident with the lateral direction in the normal state. Each fin 28 is connected to a ceiling of the actuator or otherwise fixed relative to the actuator such that they project downward toward the AC register 4. Each fin 28 also extends in the actuator-normal direction. However, each fin 28 is slim in the actuator-lateral direction, creating a low profile in an actuator-normal direction. The fins 28 are so configured, in part, to permit airflow with minimal drag in the longitudinal direction in the normal state. The fins 28 are arranged with respect to one another in the actuator-lateral direction. In other words, in the normal state, the fins 28 are configured to provide a maximized effective cross-sectional area of the guide vane inlet 22 in the longitudinal direction. The arrangement of the fins 28 in the actuator-lateral direction can be configured to provide even support to the actuator.

FIG. 7 illustrates an embodiment of the forced air splitter 100 in the normal state including the stator 12 and an actuator in an exploded view. Specifically, FIG. 7 shows the configuration of the ribs 18 reciprocating the contour of the actuator such that the ribs 18 abut the actuator along the actuator travel path. In some embodiments. In some embodiments, the actuator is a rotor 14 with curved or domed top surface, for aerodynamic duct airflow efficiencies, that is reciprocated by curving surfaces of the ribs 18. The ribs 18 can be of varying heights along the lateral direction to properly mate with a curved or domed top surface of the rotor 14. In an embodiment, the rotor 14 is fixed vertically between the ribs 18 and an internal mounting feature near a lower end of the stator 12 or near an upper end of the AC register 4. In an embodiment, the rotor 14 is affixed to the stator 12 by a screw connection 32 in an axis of rotation of the rotor 14. The screw connection 32, in an assembled state, can be in a recessed screw hole within a center fin of the fins 28 of the rotor 14 or the top surface of the rotor 14 and connect with a center rib of the ribs 18 of the stator 12 to permit rotation along the axis of rotation of the rotor 14. The actuator includes an actuator wall. In the case of FIG. 7, this is a rotor wall 26 of rotor 14.

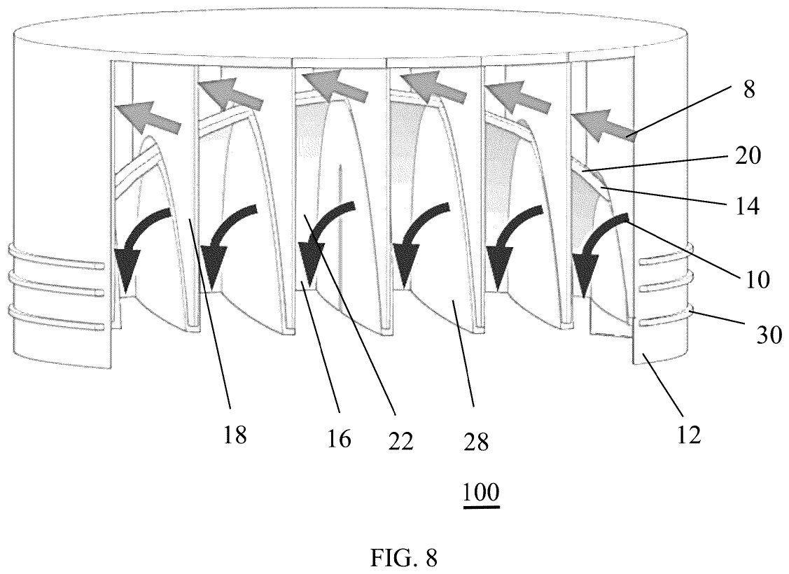

FIG. 8 illustrates an embodiment of the forced air splitter 100 wherein the guide vane 20 has an inlet 22 extending into the AC duct 2 and into the duct airflow 8, splitting a local airflow 10 from the duct airflow 8. The guide vane 20 communicates the local airflow 10 to the local AC register 4 and thereafter the interior environment. Because of the position of the stator 12 and the position of the guide vane inlet 22 in the normal state in the AC duct 2, the guide vane 20 physically intercepts or splits, within the AC duct 2, a local airflow 10 away from the duct airflow 8. The guide vane 20 funnels the local airflow 10 away from the duct airflow 8 toward the local AC register 4 and the associated local area thereafter. A stator opening 16 in the stator 12 permits duct airflow 8 to pass through the stator opening 16 to continue to travel along the AC duct 2 in the longitudinal direction.

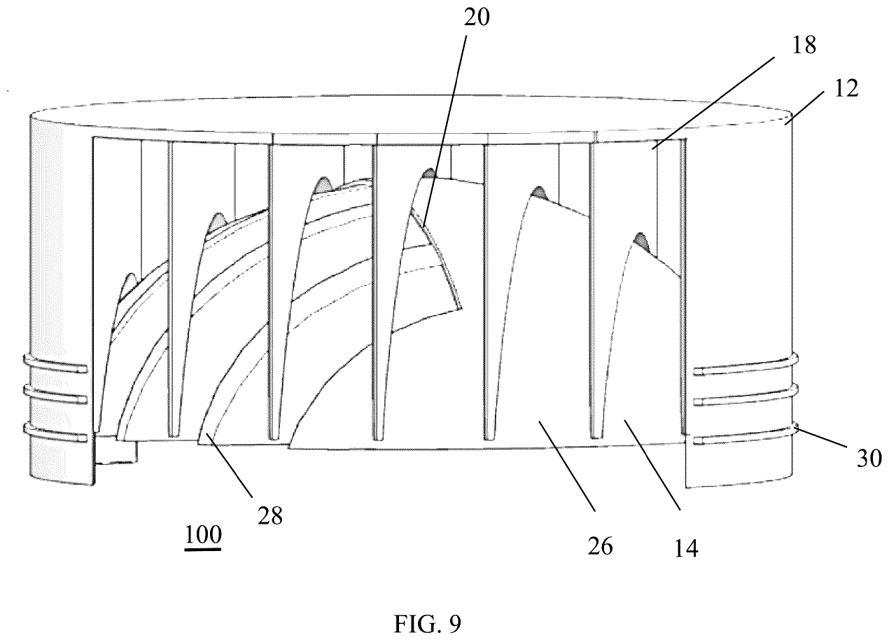

FIG. 9 illustrates an embodiment of the forced air splitter 100 in an intermediate state. The stator 12 of the forced air splitter 100 remains stationary during actuation of the forced air splitter 100 from the normal state towards the intermediate state. However, the actuator actuates away from the normal state towards the intermediate state.

The actuator actuates within the stator opening 16, along the travel path, away from the normal state toward the intermediate state, such that the effective cross-sectional area of the guide vane inlet 22 in the longitudinal direction decreases, resulting in a proportion of the local airflow 10 to duct airflow 8 decreasing. It is understood that the actuator can actuate back towards the normal state, with the opposite effect. The actuation creates a throttled control over the local airflow 10 at that local AC register 4 and local zone. Actuation can be leveraged by a user to increase or decrease the amount of airflow that is physically intercepted or split away from the AC duct 2 from deep within the AC duct 2, offering a more flexible level of user control.

In some embodiments, the actuator actuates by translating the guide vane inlet 22 along the travel path, either deeper or shallower into the AC duct 2. In an embodiment, the actuator actuates along the travel path to supplant the effective cross-sectional area of the guide vane inlet 22 in the longitudinal direction with an actuator wall that blocks airflow from being intercepted or split from the duct airflow 8 and redirects the duct airflow 8 around the actuator.

In some embodiments, the actuator is a rotor 14 which rotates within the stator 12, along a rotational travel path defined by the ribs 18.

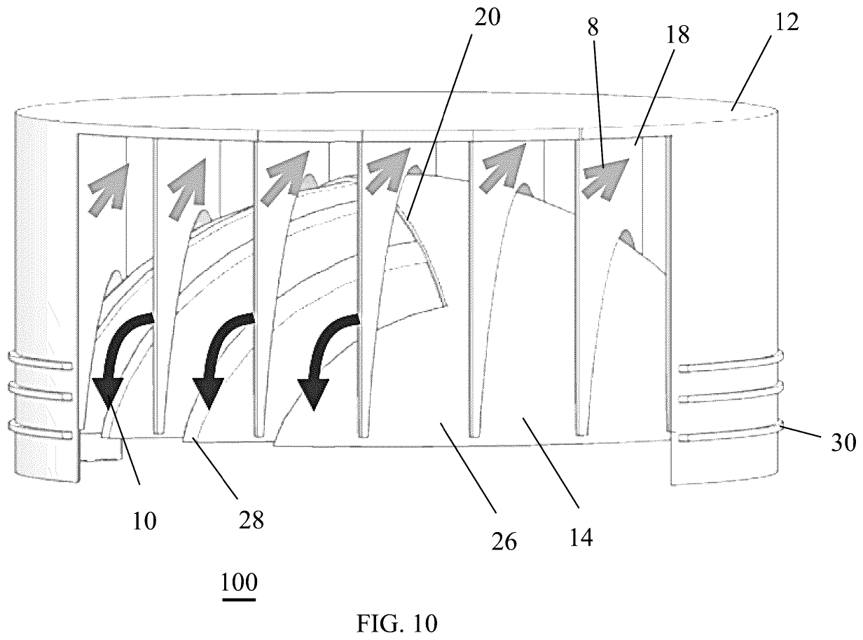

In some embodiments, as shown in FIG. 10, the rotor 14 rotates to supplant the effective cross-sectional area of the guide vane inlet 22, in the longitudinal direction, with a rotor wall 26 that blocks airflow from being intercepted or split from the duct airflow 8 by inlet 22 and/or redirects the duct airflow 8 over the rotor 14. The local airflow 10 is readily appreciable as diminished in the intermediate state of FIG. 10, compared to the greater local airflow 10 in the normal state shown in FIG. 8.

The rotor wall 26 can be a curved or domed top surface, such as in FIG. 10. Aerodynamic duct airflow 8 efficiencies for a curved or domed top surface rotor 14 are readily appreciable in this case, as other possible embodiments, though still advantageous in the manners described above, trap airflow between in an elongated valley or “v” shaped groove formed by the rotor or actuator wall 26 and a rib 18, wherein the groove is normal to the longitudinal direction, creating undesirable AC duct drag and overall diminished airflow, both to the local AC register 4 and local zone as well as subsequent AC registers 4 and zones. On the other hand, the curved or domed top surface rotor's analogous valleys or grooves, created on an external side of the rotor's top surface, are swept back and usher duct airflow 8 past the rotor wall 26 and ribs' obstructions with minimal drag. This same curved or domed top surface simultaneously provides an aerodynamically efficient travel path on an internal side in communicating the local airflow 10 from the guide vane inlet 22 to the local AC register 4 via the guide vane outlet 24, via the sloping contour of the rotor's top surface. Such an embodiment minimizes drag on both sides of the rotor 14.

As previously illustrated in FIG. 6, in an embodiment, an actuator such as rotor 14 faces the longitudinal direction in the normal state and has an actuator-normal direction that is coincident with the longitudinal direction in the normal state. The actuator further has an actuator-lateral direction that is coincident with the lateral direction in the normal state.

As illustrated in FIG. 9, rotation of the actuator such as a rotor 14 away from the normal position towards the intermediate position causes the actuator-normal direction to rotate relative to the longitudinal direction and the actuator-lateral direction to rotate relative to the lateral direction, which in turn rotates the fins 28 such that the slim dimension of the fins in the actuator-lateral direction, creating the low profile in the actuator-normal direction, is replaced with a larger dimension of the fins in either of the downward or actuator-lateral direction. This creates a higher profile of the fins in the longitudinal direction, blocking a greater portion of the effective cross-sectional area of the guide vane inlet 22 in the longitudinal direction, which effectively reduces the effective cross-sectional area of the guide vane inlet 22 in the longitudinal direction. The ribs 18 of the stator 12 are configured to simultaneously abut the actuator such that the actuator can actuate along a consistent travel path while still permitting duct airflow 8 to pass through the stator opening 16, as can be seen, for example, in the actuation from the normal state of FIG. 6 towards the intermediate state of FIG. 9.

FIG. 9 illustrates an embodiment with a rotor 14 rotating that combines both supplanting the effective cross-sectional area of the guide vane inlet 22 in the longitudinal direction with a rotor wall 26 or curved or domed top surface as well as rotating the fins 28 to block a greater portion of the effective cross sectional area of the guide vane inlet 22 in the longitudinal direction, both of which effectively reduce the effective cross-sectional area of the guide vane inlet 22 in the longitudinal direction. However, it is understood that embodiments of the present disclosure are not limited thereto.

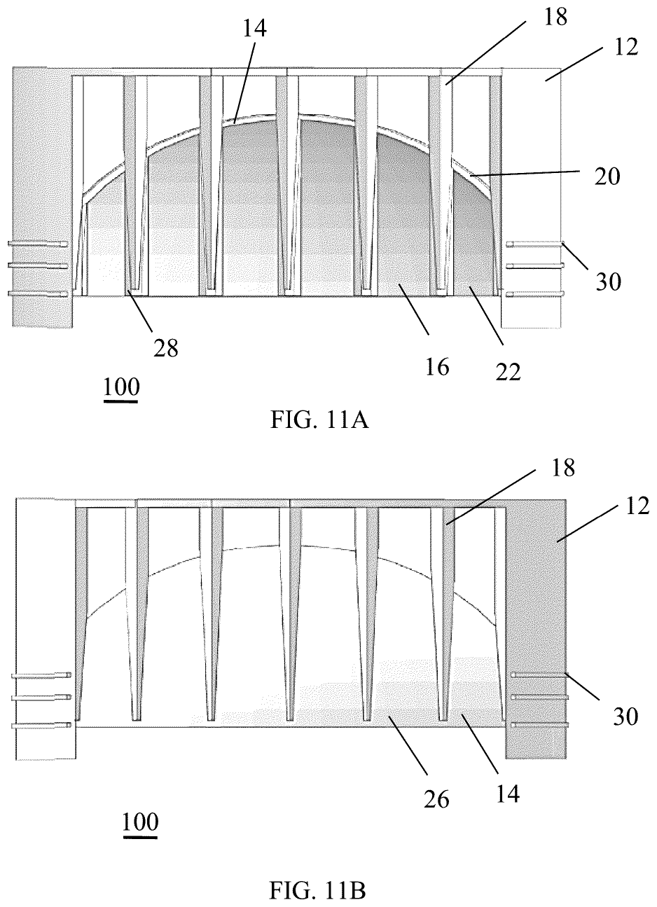

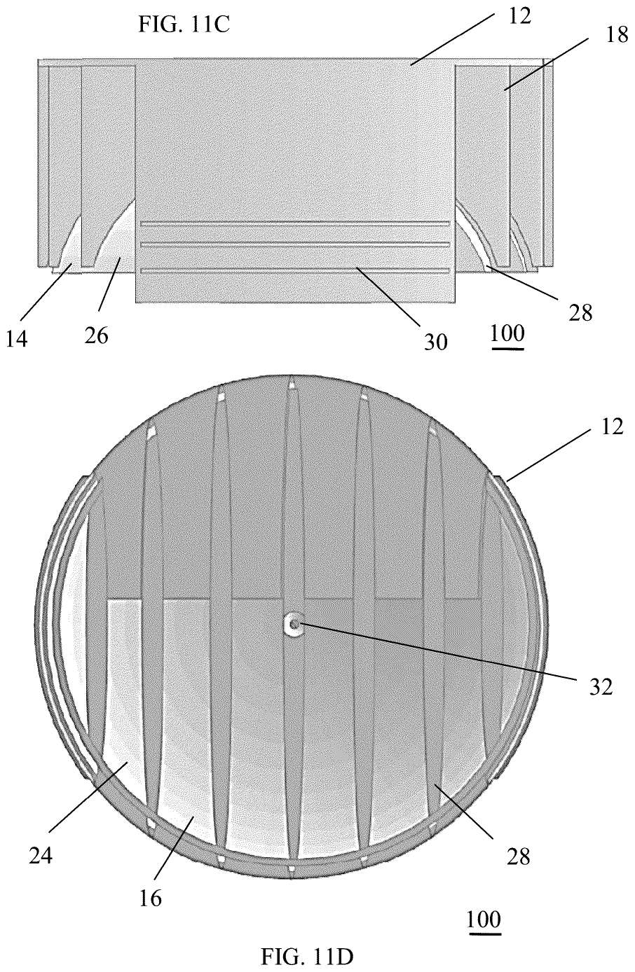

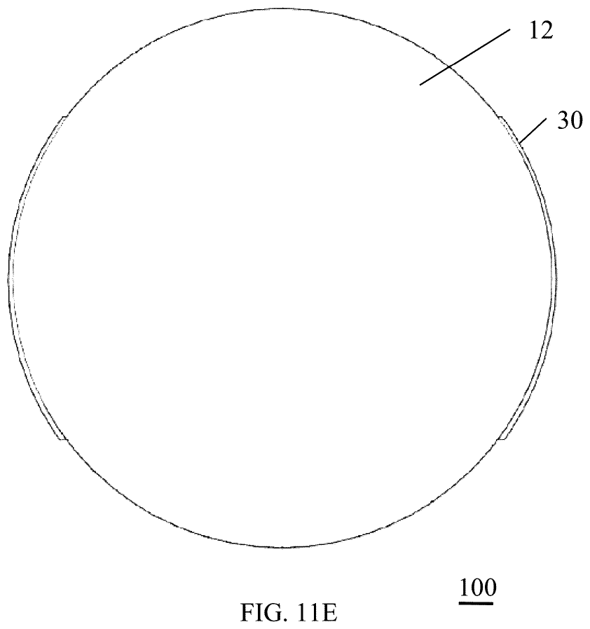

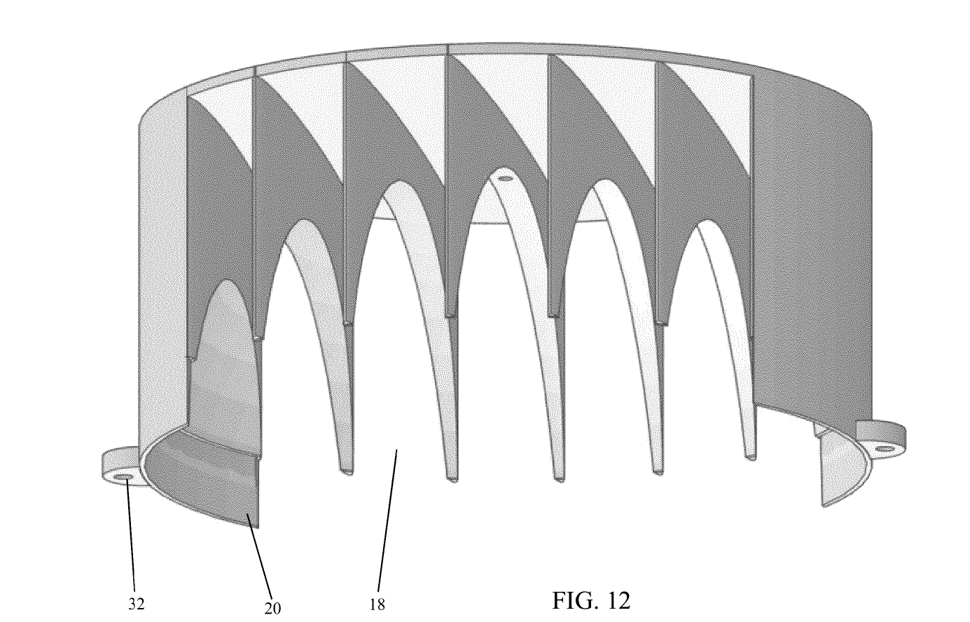

FIG. 11A illustrates an embodiment of a forced air splitter 100 of the present disclosure in a normal state in a view in the longitudinal direction, specifically facing downstream with respect to the duct airflow 8. The forced air splitter 100 includes a stator 12 and an actuator such as a rotor 14. The actuator is positioned within the stator 12. The stator 12 includes a stator opening 16 with a plurality of ribs 18 located therein. Each rib 18 is connected to a ceiling of the stator 12 or otherwise fixed relative to the stator 12 such that they project downward toward the actuator. Each rib 18 further extends in the longitudinal direction, being configured to abut the actuator and/or abut the actuator's travel path. However, each rib 18 is slim in the lateral direction, creating a low profile in an longitudinal direction. The ribs 18 are so configured, in part, to permit airflow with minimal drag in the longitudinal direction. The ribs 18 are arranged with respect to one another in the lateral direction. The arrangement of the ribs 18 in the lateral direction can be configured to provide even support to the stator 12 and the actuator. The actuator is arranged in the stator opening 16. The actuator includes a guide vane 20 having an inlet 22 for airflow. The rotor 14 includes a plurality of fins 28. In some embodiments, the stator 12 includes three rings 30, for mating with the AC system 200. In an embodiment, an actuator such as rotor 14 faces the longitudinal direction in the normal state and has an actuator-normal direction that is coincident with the longitudinal direction in the normal state. The actuator further has an actuator-lateral direction that is coincident with the lateral direction in the normal state. Each fin 28 is connected to a ceiling of the actuator or otherwise fixed relative to the actuator such that they project downward toward the AC register 4. Each fin 28 also extends in the actuator-normal direction. However, each fin 28 is slim in the actuator-lateral direction, creating a low profile in an actuator-normal direction. The fins 28 are so configured, in part, to permit airflow with minimal drag in the longitudinal direction in the normal state. The fins 28 are arranged with respect to one another in the actuator-lateral direction. In other words, in the normal state, the fins 28 are configured to provide a maximized effective cross-sectional area of the guide vane inlet 22 in the longitudinal direction. The arrangement of the fins 28 in the actuator-lateral direction can be configured to provide even support to the actuator.

FIG. 11B illustrates an embodiment of a forced air splitter 100 of the present disclosure in a normal state in a view in the longitudinal direction, specifically facing upstream with respect to the duct airflow 8. The actuator includes an actuator wall. In the case of FIG. 11B, this is a rotor wall 26 of rotor 14.

FIG. 11C illustrates an embodiment of a forced air splitter 100 of the present disclosure in a normal state in a view in the longitudinal direction, specifically facing upstream with respect to the duct airflow 8. The actuator includes an actuator wall. In the case of FIG. 11B, this is a rotor wall 26 of rotor 14.

FIG. 11D illustrates an embodiment of a forced air splitter 100 of the present disclosure in a normal state in a bottom view. The actuator includes an outlet 24 which communicates the inlet 22 with the local AC register 4 and the associated local area such that local airflow 10 is communicated to the AC register 4 and the local area. In an embodiment, the rotor 14 is affixed to the stator 12 by a screw connection 32 in an axis of rotation of the rotor 14. The screw connection 32, in an assembled state, can be in a recessed screw hole within a center fin of the fins 28 of the rotor 14 or the top surface of the rotor 14 and connect with a center rib of the ribs 18 of the stator 12 to permit rotation along the axis of rotation of the rotor 14.

FIG. 11E illustrates an embodiment of a forced air splitter 100 of the present disclosure in a normal state in a top view. In some examples, the stator 12 includes three rings 30 for mating with the AC system 200.

The stator 12 mates to an AC duct 2 with a snap in feature or other appropriate fixing feature. AC ducts 2 have an existing local opening to communicate the AC duct 2 with a local AC register 4. The stator 12 is configured to mate with the AC duct 2 local opening. FIG. 12 illustrates an embodiment of the stator 12 configured to mate with the AC duct 2 or the local AC register 4 by a screw-in connection at screw-in tabs 32. In some embodiments, the stator 12 is configured to be installed at a local opening formed in an AC duct 2. The stator 12 may be sized and shaped to engage the opening in a sealing relationship, enabling potential communication of airflow between the interior of the duct 2 and a local air register 4 without escaped airflow bypassing the local AC register 4, i.e., ensuring airflow integrity. The AC register 4 may be mounted adjacent to or spaced from the opening, such as on a wall or ceiling of a zone of the interior environment. In some embodiments, the stator 12 is configured to snap into or otherwise engage directly with the duct opening. Engagement may occur through one or more retention features, such as flexible tabs, snap rings, or compressible ribs, which are fitted to reciprocating slots or rings or resiliently biased to expand once the stator 12 is inserted into the opening.

In some embodiments, the stator 12 further includes features that inhibit rotational movement once installed, particularly where the duct opening is round. Anti-rotation structures engage complementary features in the duct opening or AC register 4, or a mounting collar therein. In this manner, actuation or rotation of the stator 12 can be avoided, which would disrupt the relationship of the stator opening 16 to the AC duct 2 and the duct airflow 8. In an embodiment, a universal mounting collar or interface ring is first installed into the duct opening. This collar may include any appropriate mating features as those described with respect to the stator 12 above. Once installed, the collar defines a standardized mechanical interface, into which the stator 12 can be inserted and secured. For example, the collar may include internal locking grooves or ring seats, and the stator 12 may include corresponding engagement flanges or expandable elements that snap or rotate into place. For example, the stator could include three rings 30 that snap into retention features in the universal mounting collar. In other embodiments as illustrated in FIG. 12, the stator 12 is configured to mate with the collar by a screw-in connection at screw-in tabs 32. The use of such an intermediate collar allows the stator 12 to be removed, replaced, or upgraded without disturbing the AC duct wall 2a or the AC register 4 installation. The collar and stator 12 may each include optional axial adjustment features, such as telescoping sections or stackable spacers, to account for variable wall thickness, separation of the AC duct wall 2a from the interior environment ceiling, or AC register 4 setback. Additional sealing components may be disposed between the stator 12 and the collar to ensure airflow integrity.

The stator 12 is understood to be similarly suitable for any of the aforementioned configurations, and/or to directly mate with the AC register 4 such that the stator 12 bridges spacing between the AC duct opening and the AC register 4 mounting locations. In some examples, the AC register 4 is received into a portion of the stator 12, or vice versa, to ensure coaxial alignment and minimize installation error.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A forced air splitter, for an air conditioning (AC) duct both extending in and configured for duct airflow in a longitudinal direction, the forced air splitter splitting a local airflow from the duct airflow and communicating the local airflow to a local AC register, the forced air splitter comprising:
a stator with a stator opening, the stator opening including a plurality of ribs, the stator extending from a wall of the AC duct into the AC duct and into the duct airflow; and
an actuator arranged within the stator opening and between the plurality of ribs and the local AC register, the actuator including a guide vane having an inlet extending into the AC duct and into the duct airflow for splitting the local airflow from the duct airflow and an outlet communicating the inlet with the local AC register for communicating the local airflow to the local AC register,
wherein the plurality of ribs are configured to permit the actuator to actuate,
wherein the inlet has an effective cross-sectional area in the longitudinal direction in the AC duct, and
wherein actuation of the actuator from a normal state toward an intermediate state decreases the effective cross-sectional area of the inlet in the longitudinal direction in the AC duct.

2. The forced air splitter of claim 1, the actuator further comprising an actuator wall, wherein actuation from the normal state toward the intermediate state causes the actuator wall to supplant the inlet in the longitudinal direction, decreasing the effective cross-sectional area of the inlet in the longitudinal direction in the AC duct.

3. The forced air splitter of claim 1, the actuator further comprising a plurality of fins arranged within the guide vane and extending in an actuator-normal direction, the plurality of fins spaced apart from one another in an actuator-lateral direction,
wherein actuation of the actuator causes the actuator-normal direction to actuate relative to the longitudinal direction and the plurality of fins to restrict the local airflow, decreasing the effective cross-sectional area of the inlet in the longitudinal direction in the AC duct.

4. The forced air splitter of claim 3, wherein the actuator is a rotor that is coaxial with the configuration of the ribs such that the actuation of the rotor comprises rotation within the ribs, and wherein the actuator-normal direction is parallel to the longitudinal direction in a normal state and actuates toward the lateral direction during rotation from the normal state toward an intermediate state.

5. The forced air splitter of claim 4, wherein the rotor further comprises a rotor wall, wherein the rotation from the normal state toward the intermediate state causes the rotor wall to supplant the inlet in the longitudinal direction, decreasing the effective cross-sectional area of the inlet in the longitudinal direction in the AC duct.

6. The forced air splitter of claim 4, wherein the ribs are configured to reciprocate a domed top surface of the rotor.

7. The forced air splitter of claim 1, wherein the local airflow comprises a portion of the duct airflow, wherein the inlet comprises an upper lip within the AC duct, the upper lip intercepting the portion of the duct airflow comprising the local airflow and redirecting it away from the longitudinal direction.

8. A system of air conditioning (AC) management comprising:
an air-conditioner or forced air device;
an AC duct in communication with the air-conditioner or forced air device such that the air-conditioner or forced air device creates a duct airflow in a longitudinal direction of the AC duct; and
a plurality of local AC registers in communication with the AC duct in sequence in the longitudinal direction of the AC duct, each of the plurality of the local AC registers having a forced air splitter splitting a local airflow from the duct airflow and communicating the local airflow to the local AC register, the forced air splitter including:
a stator with a stator opening, the stator opening including a plurality of ribs, the stator extending from a wall of the AC duct into the AC duct and into the duct airflow; and
an actuator arranged within the stator opening and between the plurality of ribs and the local AC register, the actuator including a guide vane having an inlet extending into the AC duct and into the duct airflow for splitting the local airflow from the duct airflow and an outlet communicating the inlet with the local AC register for communicating the local airflow to the local AC register,
wherein the plurality of ribs are configured to permit the actuator to actuate,
wherein the inlet has an effective cross-sectional area in the longitudinal direction in the AC duct, and
wherein actuation of the actuator from a normal state toward an intermediate state decreases the effective cross-sectional area of the inlet in the longitudinal direction in the AC duct;
wherein the local airflows among the plurality of local AC registers are balanced by actuation of the actuators without manipulating the local AC registers.

9. The system of AC management of claim 8, the actuator further comprising an actuator wall, wherein actuation from the normal state toward the intermediate state causes the actuator wall to supplant the inlet in the longitudinal direction, decreasing the effective cross-sectional area of the inlet in the longitudinal direction in the AC duct.

10. The system of AC management of claim 8, the actuator further comprising a plurality of fins arranged within the guide vane and extending in an actuator-normal direction, the plurality of fins spaced apart from one another in an actuator-lateral direction,
wherein actuation of the actuator causes the actuator-normal direction to actuate relative to the longitudinal direction and the plurality of fins to restrict the local airflow, decreasing the effective cross-sectional area of the inlet in the longitudinal direction in the AC duct.

11. The system of AC management of claim 10, wherein the actuator is a rotor that is coaxial with the configuration of the ribs such that the actuation of the rotor comprises rotation within the ribs, and wherein the actuator-normal direction is parallel to the longitudinal direction in a normal state and actuates toward the lateral direction during rotation from the normal state toward an intermediate state.

12. The system of AC management of claim 11, wherein the rotor further comprises a rotor wall, wherein the rotation from the normal state toward the intermediate state causes the rotor wall to supplant the inlet in the longitudinal direction, decreasing the effective cross-sectional area of the inlet in the longitudinal direction in the AC duct.

13. The system of AC management of claim 11, wherein the ribs are configured to reciprocate a domed top surface of the rotor.

14. A recreational vehicle (RV), the RV comprising:
an air-conditioner;
an AC duct in communication with the air-conditioner such that the air-conditioner creates a duct airflow in a longitudinal direction of the AC duct; and
a plurality of local AC registers in communication with the AC duct in sequence in the longitudinal direction of the AC duct, each of the plurality of the local AC registers having a forced air splitter splitting a local airflow from the duct airflow and communicating the local airflow to the local AC register, the forced air splitter including:
a stator with a stator opening, the stator opening including a plurality of ribs, the stator extending from a wall of the AC duct into the AC duct and into the duct airflow; and
an actuator arranged within the stator opening and between the plurality of ribs and the local AC register, the actuator including a guide vane having an inlet extending into the AC duct and into the duct airflow for splitting the local airflow from the duct airflow and an outlet communicating the inlet with the local AC register for communicating the local airflow to the local AC register,
wherein the plurality of ribs are configured to permit the actuator to actuate,
wherein the inlet has an effective cross-sectional area in the longitudinal direction in the AC duct, and
wherein actuation of the actuator from a normal state toward an intermediate state decreases the effective cross-sectional area of the inlet in the longitudinal direction in the AC duct.

15. The RV of claim 14, the actuator further comprising an actuator wall, wherein actuation from the normal state toward the intermediate state causes the actuator wall to supplant the inlet in the longitudinal direction, decreasing the effective cross-sectional area of the inlet in the longitudinal direction in the AC duct.

16. The RV of claim 14, the actuator further comprising a plurality of fins arranged within the guide vane and extending in an actuator-normal direction, the plurality of fins spaced apart from one another in an actuator-lateral direction,
wherein actuation of the actuator causes the actuator-normal direction to actuate relative to the longitudinal direction and the plurality of fins to restrict the local airflow, decreasing the effective cross-sectional area of the inlet in the longitudinal direction in the AC duct.

17. The RV of claim 16, wherein the actuator is a rotor that is coaxial with the configuration of the ribs such that the actuation of the rotor comprises rotation within the ribs, and wherein the actuator-normal direction is parallel to the longitudinal direction in a normal state and actuates toward the lateral direction during rotation from the normal state toward an intermediate state.

18. The RV of claim 17, wherein the rotor further comprises a rotor wall, wherein the rotation from the normal state toward the intermediate state causes the rotor wall to supplant the inlet in the longitudinal direction, decreasing the effective cross-sectional area of the inlet in the longitudinal direction in the AC duct.

19. The RV of claim 17, wherein the ribs are configured to reciprocate a domed top surface of the rotor.
